(19) United States
(12) Patent Application Publication
(10) Pub. No.: US 2014/0375597 A1
(43) Pub. Date: Dec. 25, 2014

(54) THIN FILM TRANSISTOR ARRAY SUBSTRATE AND DISPLAY APPARATUS INCLUDING SAME

(71) Applicant: SAMSUNG DISPLAY CO., LTD., Yongin-City (KR)

(72) Inventors: Jin-Oh Park, Yongin-City (KR); Dong-Wan Choi, Yongin-City (KR); Hyo-Sang Yang, Yongin-City (KR); Hee-Kwon Eun, Yongin-City (KR)

(73) Assignee: SAMSUNG DISPLAY CO., LTD., Yongin-City (KR)

(21) Appl. No.: 14/069,354

(22) Filed: Oct. 31, 2013

(30) Foreign Application Priority Data
Jun. 25, 2013 (KR) 10-2013-0073316

(51) Int. Cl. G06F 3/041; G06F 3/044

(52) U.S. Cl. CPC G06F 3/0412; G06F 3/044; G06F 3/0416
USPC 345/174; 345/173

(57) ABSTRACT

A thin film transistor array substrate includes: an active area including a plurality of pixels; a driver integrated circuit in a non-active area around the active area and configured to supply a driving signal to the pixels; and a user input key positioned near the driver integrated circuit and configured to receive a user input.

### CROSS-REFERENCE TO RELATED APPLICATION

This application claims priority to and the benefit of Korean Patent Application No. 10-2013-0073316, filed on Jun. 25, 2013, in the Korean Intellectual Property Office, the disclosure of which is incorporated herein in its entirety by reference.

### BACKGROUND

1. Field

Embodiments of the present invention relate to a thin film transistor array substrate and a display apparatus including the same.

2. Description of the Related Art

Recently, mobile terminal, such as cellular phones, have employed a touch key instead of a button key as an input device. The touch key functions as the button key by detecting a touch on a specific position of a touch panel or a window by placing the touch sensor at the specific position.

### SUMMARY

Embodiments of the present invention provide a compact display apparatus capable of saving the manufacturing costs thereof and reducing the thickness of a bezel.

According to an embodiment of the present invention, there is provided a thin film transistor array substrate including: an active area including a plurality of pixels; a driver integrated circuit in a non-active area around the active area and configured to supply a driving signal to the pixels; and a user input key positioned near the driver integrated circuit and configured to receive a user input.

The user input key may include a touch sensor.

The driver integrated circuit may include a display driver configured to supply a driving signal to the active area.

The driver integrated circuit may be plural in number, wherein the plurality of driver integrated circuits may be separated from each other, and the touch sensor may be between the plurality of driver integrated circuits.

The thin film transistor array substrate may further include a touch driver configured to drive the touch sensor.

The touch driver may be integrated in the driver integrated circuit.

The touch sensor may be configured to detect a touch based on a change in capacitance between a pair of electrodes.

The pair of electrodes may be at a same layer and may be separated from each other.

The pair of electrodes may be formed of a same material as one conductive layer of a device forming a pixel included in the active area.

According to another embodiment of the present invention, there is provided a display apparatus including: a substrate including an active area and a non-active area around the active area; a plurality of pixels in the active area; a plurality of driver integrated circuits in the non-active area and configured to supply a driving signal to the pixels; and a user input key between at least two of the driver integrated circuits and configured to receive a user input.

The user input key may include a touch sensor.

Each of the plurality of driver integrated circuits may include a display driver configured to supply a driving signal to the active area.

The display apparatus may further include a touch driver for driving the touch sensor.

The touch driver may be integrated in at least one of the driver integrated circuits.

The display apparatus may further include an encapsulation member facing the substrate; and a touch panel on the encapsulation member.

The touch sensor may detect a touch based on a change in capacitance between a pair of electrodes.

The pair of electrodes may be at a same layer and separated from each other.

The pair of electrodes may be formed of a same material as one conductive layer of a device forming a pixel.

### BRIEF DESCRIPTION OF THE DRAWINGS

The above and other features and aspects of the embodiments of the present invention will become more apparent by describing in some detail example embodiments thereof with reference to the attached drawings in which:

FIG. 1 is a top view of a display apparatus according to an embodiment of the present invention;

FIG. 2 is a cross-sectional view along the line A-A′ of FIG. 1;

FIG. 3 is a cross-sectional view of a pixel according to an embodiment of the present invention;

FIG. 4 is a conceptual diagram of a touch sensor according to an embodiment of the present invention;

FIG. 5 is a conceptual diagram of a touch sensor according to another embodiment of the present invention;

FIG. 6 is a top view of a display apparatus according to another embodiment of the present invention; and

FIG. 7 is a block diagram of a driver integrated circuit in the display apparatus of FIG. 6.

### DETAILED DESCRIPTION

Hereinafter, embodiments of the present invention will be described in detail with reference to the accompanying drawings so that one of ordinary skill in the art may easily realize the present invention. However, the present invention may be embodied in many different forms and should not be construed as being limited to the embodiments set forth herein.

In the drawings, some parts irrelevant to the description are omitted to clearly describe the present invention, and like reference numerals denote like elements throughout the specification.

In addition, because the sizes and thicknesses of components in the drawings are arbitrarily shown for convenience of description, the present invention is not necessarily limited to the drawings.

In the drawings, the thicknesses may be magnified to clearly express several layers and areas. In addition, in the drawings, the thicknesses of some layers and areas are exaggerated for convenience of description. When it is described that a certain component, such as a layer, a film, an area, a plate, or the like, is “on” or “above” another component, the certain component may be directly on another component, or a third component may be interposed therebetween.

In the specification, when a certain part “includes” a certain component, this indicates that the part may further include another component instead of excluding another component unless there is different disclosure. In addition, in the specification, the term “A on B” indicates that A is located on or below B and does not indicate A is necessarily located on B based on the gravity direction.

As used herein, the term “and/or” includes any and all combinations of one or more of the associated listed items. Expressions such as “at least one of,” when preceding a list of elements, modify the entire list of elements and do not modify the individual elements of the list.

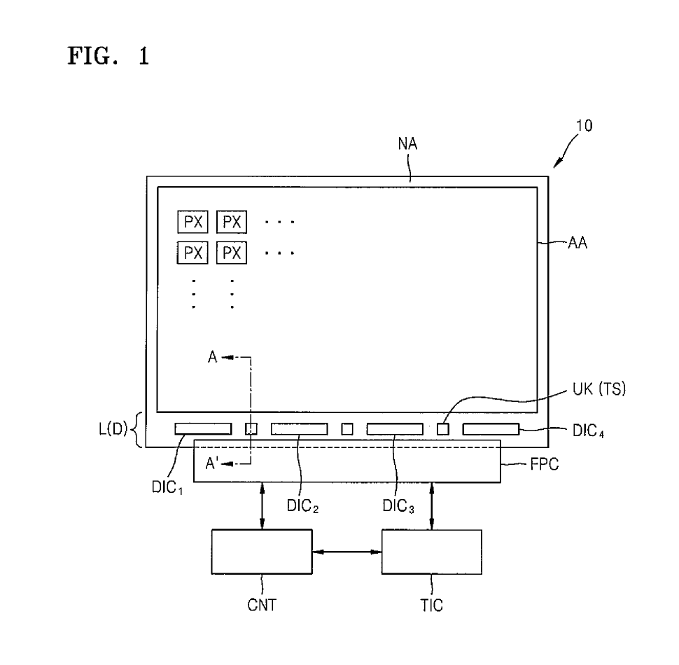

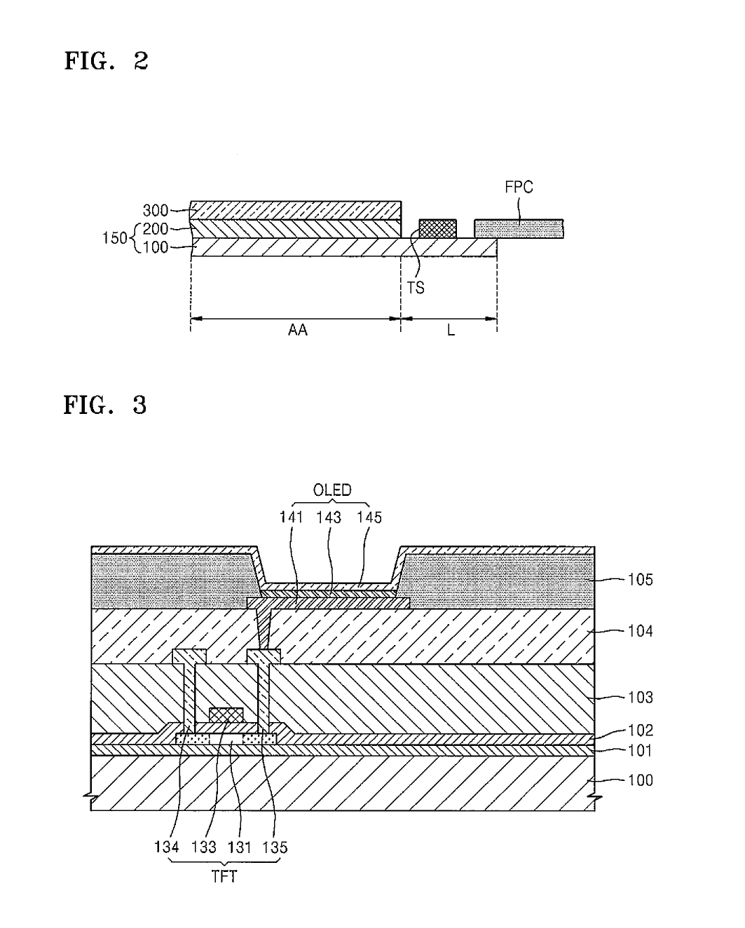

FIG. 1 is a top view of a display apparatus 10 according to an embodiment of the present invention. FIG. 2 is a cross-sectional view along the line A-A′ of FIG. 1.

Referring to FIGS. 1 and 2, the display apparatus 10 includes a display panel 150 having a first substrate 100 and a second substrate 200 bonded with or attached to the first substrate 100, for example, using a suitable sealing process. The display apparatus 10 may further include a touch panel 300 on the display panel 150.

The display apparatus 10 may include various types of display apparatuses, such as an organic light-emitting display apparatus, a liquid crystal display apparatus, an electroluminescent display apparatus, a plasma display apparatus, and the like. Hereinafter, it is described that the display apparatus 10 is an organic light-emitting display apparatus as an example.

The first substrate 100 may be a flexible substrate and may be formed of a plastic material having good heat resistance and durability, such as polyethylene terephthalate (PET), polyethylene naphthalate (PEN), polycarbonate (PC), polyarylate (PAR), polyetherimide (PEI), or the like. Alternatively, the first substrate 100 may be formed of any suitable substrate material, such as a metal, glass, and the like.

The second substrate 200 may be an encapsulation member positioned on the first substrate 100 to block (e.g., protect) a thin film transistor, an organic light-emitting device, and the like formed on the first substrate 100 from the external humidity, air, or other environmental contaminants that may interfere with the functionality of the components formed on the first substrate 100. Like the first substrate 100, the second substrate 200 may be a flexible substrate and may be formed of various materials, such as a metal, glass, and the like. The second substrate 200 may be a thin film encapsulation (TFE) layer having a structure in which a plurality of inorganic films and a plurality of organic films are alternately stacked.

The second substrate 200 is positioned to face the first substrate 100, and the first substrate 100 and the second substrate 200 are bonded with each other by a sealing member or material (not shown) formed along edges thereof.

The display panel 150 includes an active area AA in which light is emitted to display the contents of various types of images and the like on a screen and a non-active area NA around the active area AA.

The touch panel 300 detects a touch in an area corresponding to the active area AA of the display panel 150. The touch panel 300 is an input device for inputting a user's command by selecting an indication displayed on a screen with a human hand or an object. To this end, the touch panel 300 is positioned on the front face of the display apparatus 10 and converts a touch position directly contacted with a human hand or an object into an electrical signal. Accordingly, an indication selected at the touch position is input as an input signal. The touch panel 300 may replace or supplement a separate input device, such as a keyboard or a mouse.

The touch panel 300 may be implemented in a resistive type, a photosensitive (e.g., infrared) type, a capacitive type, or the like, wherein the touch panel 300 of the capacitive-type converts a touch position into an electrical signal by detecting a change in a capacitance formed between a conductive sensing pattern and another neighboring sensing pattern or a ground electrode when a human hand or an object contacts the touch panel 300. A window (not shown) may be further included on the touch panel 300 to increase a mechanical strength of the touch panel 300 and to protect the touch panel 300 from external or environmental contaminants. Alternatively, the touch panel 300 may be a window-integrated touch panel including a window function.

In the active area AA of the first substrate 100, a plurality of scan lines, a plurality of data lines, and a plurality of pixels PX are included. The plurality of scan lines are arranged in rows and are separated by a distance (e.g., a constant distance) from each other, each scan line delivering a scan signal, and the plurality of data lines are arranged in columns and are separated by a distance (e.g., constant distance) from each other, each data line delivering a data signal. The plurality of scan lines and the plurality of data lines are arranged in a matrix form, and a pixel PX may be repeatedly formed or positioned at cross points therebetween in column and row directions. Each pixel PX may include a pixel circuit, which includes at least one thin film transistor and at least one capacitor, and a light-emitting device that emits light by the pixel circuit. An arrangement of a thin film transistor, a light-emitting device, a capacitor, and the like is referred to as a thin film transistor array. The first substrate 100 may be a thin film transistor array substrate having a thin film transistor array formed in the active area AA.

At one side of the non-active area NA of the first substrate 100, a driver integrated circuit (DIC) in which a driver for the display panel 150 (hereinafter, referred to as “display driver”) that supplies a driving signal for driving pixels PX in the active area AA is integrated is mounted in a chip on glass (COG) scheme. An area in which the DIC is mounted is referred to as a ledge L.

On the first substrate 100, one DIC may be mounted, or a plurality of DICs corresponding to a plurality of regions of the active area AA may be mounted. In the embodiment of FIG. 1, first to fourth DICs DIC₁ to DIC₄ for respectively supplying driving signals to four regions are shown, but the present invention is not limited thereto, and one or more DICs may be included.

The display driver may include one or more scan drivers for sequentially applying scan signals to the plurality of scan lines and/or one or more data drivers for applying data signals to the plurality of data lines. The one or more scan drivers may be directly formed in the non-active area NA of the first substrate 100.

In a region in which the DIC is positioned, a user interface key UK may be formed near the DIC. The user interface key UK may include a menu key, a previous key, or the like implemented with a physical home key or a touch sensor and may be positioned between at least two of the plurality of DICs. The user interface key UK may include a touch sensor TS for detecting a touch of a user. Hereinafter, it is described that the user interface key UK is the touch sensor TS as an example.

In the current embodiment, the touch sensor TS is formed on the first substrate 100 of the display panel 150 as the user interface key or the user input key UK. The touch sensor TS is formed at one side of the non-active area NA of the first substrate 100 in a process of forming pixels PX in the active area AA of the first substrate 100. Thus, because the touch sensor TS can be mounted in the display panel 150 without an additional process or additional parts to form the touch sensor TS, manufacturing costs can be saved. In addition, in the current embodiment, because a space for positioning the touch sensor TS in addition to the DIC does not have to be secured at the lower end of the ledge L by forming the touch sensor TS around the DIC in the ledge L of the first substrate 100, the thickness D of the non-active area NA at the lower end of the display panel 150 may be minimized.

A flexible printed circuit FPC may be attached at one side of the non-active area NA, for example, a region in which the DIC is mounted. The flexible printed circuit FPC electrically couples the DIC and an external circuit. The external circuit may include a control unit CNT and a touch driver integrated circuit TIC in which a driver for the touch panel 300 (hereinafter, referred to as “touch driver”) is integrated. The control unit CNT and the touch driver integrated circuit TIC may be integrated in a printed circuit board (PCB), and the flexible printed circuit FPC may electrically couple the DIC to the PCB.

According to an embodiment of the present invention, one FPC is shared for signal transmission and reception with the display panel 150 and signal transmission and reception with the touch sensor TS.

The control unit CNT generates a control signal based on power input from the outside and transmits the control signal to the DIC via the flexible printed circuit FPC. Accordingly, the scan driver sequentially applies scan signals to the plurality of scan lines, and the data driver applies data signals to each pixel PX. The control unit CNT may be implemented by a microprocessor unit (MPU), a control algorithm stored in a memory medium (read only memory (ROM), random access memory (RAM), and the like) coupled to the MPU, and the like. In addition, the control unit CNT generates a control signal based on power input from the outside and transmits the control signal to the touch driver integrated circuit TIC.

In the touch driver integrated circuit TIC, the touch driver for driving the touch panel 300 and the touch sensor TS via the flexible printed circuit FPC based on the control signal from the control unit CNT may be integrated. The touch driver may receive a touch detection signal output from each of the touch panel 300 and the touch sensor TS. A plurality of touch drivers may be included in the touch driver integrated circuit TIC to drive the touch panel 300 and the touch sensor TS and receive touch detection signals. The control unit CNT receives and processes a touch detection signal from the touch driver to execute an operation (e.g., a pre-defined operation).

FIG. 3 is a cross-sectional view of a pixel according to an embodiment of the present invention.

Referring to FIG. 3, a buffer layer 101 is formed on the first substrate 100, and a pixel circuit including a thin film transistor TFT is formed on the buffer layer 101.

The buffer layer 101 functions to prevent the infiltration of impurity elements and planarize the surface of the first substrate 100 and may be formed of various suitable materials for this function. For example, the buffer layer 101 may be formed of an inorganic material, such as a silicon oxide, a silicon nitride, a silicon oxynitride, an aluminum oxide, an aluminum nitride, a titanium oxide, a titanium nitride, or the like, an organic material, such as polyimide, polyester, acryl, or the like, or a laminated body thereof. The buffer layer 101 may be included according to the design and function of the display apparatus 10.

An active layer 131 is formed on the buffer layer 101. The active layer 131 may be formed of an inorganic semiconductor, such as amorphous silicon or polysilicon, or an organic semiconductor. The active layer 131 has a source region, a drain region, and a channel region therebetween.

A gate insulating layer 102 is formed on the buffer layer 101 to cover the active layer 131, and a gate electrode 133 is formed on the gate insulating layer 102 to correspond to or overlap the channel region of the active layer 131. The gate insulating layer 102 may be formed of an organic insulating material or an inorganic insulating material, or in a multi-layer structure in which an organic insulating material and an inorganic insulating material are alternated. The gate electrode 133 may include at least one material selected from among silver (Ag), magnesium (Mg), aluminum (Al), platinum (Pt), palladium (Pd), gold (Au), nickel (Ni), neodymium (Nd), iridium (Ir), chromium (Cr), lithium (Li), calcium (Ca), molybdenum (Mo), titanium (Ti), tungsten (W), molybdenum tungsten (MoW), and copper (Cu).

An interlayer insulating layer 103 is formed on the gate insulating layer 102 to cover the gate electrode 133, and a source electrode 134 and a drain electrode 135 are formed on the interlayer insulating layer 103 and respectively contact the source region and the drain region of the active layer 131 through contact holes. The interlayer insulating layer 103 may be formed of an organic insulating material or an inorganic insulating material, or in a multi-layer structure in which an organic insulating material and an inorganic insulating material are alternated. The source electrode 134 and the drain electrode 135 may be formed of a material selected from among the same materials as the gate electrode 133 but are not limited thereto and may be formed of various conductive materials.

A structure of the thin film transistor TFT is not necessarily limited to the shown structure, and various types of thin film transistor structures is of course applicable.

A passivation layer 104 is formed on the interlayer insulating layer 103 to cover the thin film transistor TFT. The passivation layer 104 may be an insulating layer having a single or multiple layers of which the upper surface is planarized. The passivation layer 104 may be formed of an inorganic material and/or an organic material.

A first electrode 141 of an organic light-emitting device OLED electrically coupled to the thin film transistor TFT is formed on the passivation layer 104. A pixel defining layer 105 that covers the outer circumference of the first electrode 141 is formed, and an aperture (e.g., a predetermined aperture) is formed in the pixel defining layer 105 to expose the first electrode 141.

An intermediate layer 143 including an organic light-emitting layer is formed on the exposed upper surface of the first electrode 141, and a second electrode 145 that covers the intermediate layer 143 and the pixel defining layer 105 and faces the first electrode 141 is formed. As such, the organic light-emitting device OLED including the first electrode 141, the intermediate layer 143, and the second electrode 145 is formed.

The pixel defining layer 105 may be formed of an organic material, such as a polyacrylates resin, polyimides, or the like, a silica type inorganic material, or the like.

The intermediate layer 143 may be formed by stacking an organic emission layer (EML) and one or more layers from among other function layers, such as a hole transport layer (HTL), a hole injection layer (HIL), an electron transport layer (ETL), and an electron injection layer (EIL) in a single or complex structure. The organic EML may be formed of a low-molecular or high-molecular organic material. When the organic EML emits red, green, and blue lights, the organic EML may be patterned as a red EML, a green EML, and a blue EML according to a red sub-pixel, a green sub-pixel, and a blue sub-pixel. When the organic EML emits white light, the organic EML may have a multi-layer structure in which a red EML, a green EML, and a blue EML are stacked or a single-layer structure including a red emission material, a green emission material, and a blue emission material to emit the white light.

When a display apparatus has a top emission structure, the first electrode 141 may be a reflective electrode, and the second electrode 145 may be a phototransmissive electrode. In this case, the second electrode 145 may include a half-transmissive reflective film formed as a thin film of Ag, Mg, Al, Pt, Pd, Au, Ni, Nd, Ir, Cr, Li, Ca, or the like or a phototransmissive metal oxide, such as an indium tin oxide (ITO), an indium zinc oxide (IZO), a zinc oxide (ZnO), or the like. When a display apparatus has a bottom emission structure, the second electrode 145 may have a reflective function by depositing Ag, Mg, Al, Pt, Pd, Au, Ni, Nd, Ir, Cr, Li, Ca, or the like. When the first electrode 141 is used as an anode electrode, the first electrode 141 includes a layer formed of a metal oxide having a high work function (absolute value), such as ITO, IZO, ZnO, an indium oxide (In₂O₃), or the like. When the first electrode 141 is used as a cathode electrode, a high conductive metal having a low work function (absolute value), such as Ag, Mg, Al, Pt, Pd, Au, Ni, Nd, Ir, Cr, Li, Ca, or the like, is used. The second electrode 145 is used as a cathode electrode when the first electrode 141 is used as an anode electrode, and the second electrode 145 is used as an anode electrode when the first electrode 141 is used as a cathode electrode.

Although FIG. 3 shows one thin film transistor TFT, the present invention is not limited thereto. Thus, one pixel may include two or more thin film transistors TFT and one or more capacitors, and a separate wiring may be further formed, or an existing wiring may be omitted to have various structures.

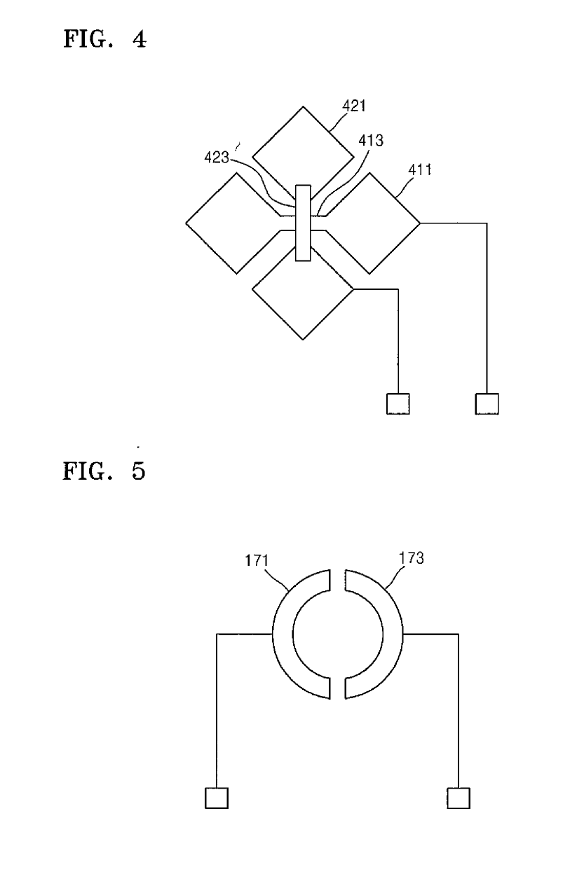

FIG. 4 is a conceptual diagram of a touch sensor TS according to an embodiment of the present invention.

Referring to FIG. 4, the touch sensor TS includes two first electrode patterns 411 in a first direction and two second electrode patterns 421 in a second direction that is orthogonal to the first direction. The two first electrode patterns 411 and the two second electrode patterns 421 approximately have a diamond shape and are alternately formed not to overlap each other in a same layer. The two first electrode patterns 411 and a first connection pattern 413 may be formed in one body (e.g., as a continuous layer) so that the two first electrode patterns 411 are coupled to each other by the first connection pattern 413. An insulating layer (not shown) may be formed on the two first electrode patterns 411 and the two second electrode patterns 421, and the two second electrode patterns 421 may be coupled to each other by a second connection pattern 423 on the insulating layer through contact holes.

The two first electrode patterns 411 and the two second electrode patterns 421 may be formed of a conductive material. The two first electrode patterns 411 and the two second electrode patterns 421 may be formed in a photolithography process. That is, the two first electrode patterns 411 and the two second electrode patterns 421 may be formed by patterning a conductive layer formed using a suitable technique, such as deposition, spin coating, sputtering, inkjet, or the like.

The two first electrode patterns 411 and the two second electrode patterns 421 may be formed as one conductive layer of a device forming a pixel PX in the active area AA. For example, the two first electrode patterns 411 and the two second electrode patterns 421 may be formed of the same material in the same layer as the gate electrode 133 or the source/drain electrode 134/135 forming the thin film transistor TFT or formed of the same material in the same layer as the first electrode 141 of the organic light-emitting device OLED. The second connection pattern 423 may be formed of the same material as or a different material from the two second electrode patterns 421.

A user's touch may be detected by a change in a capacitance between the two first electrode patterns 411 and the two second electrode patterns 421. When a touch is detected, a function allocated to the touch sensor TS is performed. The function allocated to the touch sensor TS may be differently set according to a combination of the number of touches, a touch duration, and the like.

FIG. 5 is a conceptual diagram of a touch sensor TS according to another embodiment of the present invention.

Referring to FIG. 5, the touch sensor TS includes a transmission electrode 171 and a reception electrode 173 formed in a same layer to face each other and to be separated by a distance (e.g., a predetermined distance) from each other. Although an electrode pattern of the transmission electrode 171 and the reception electrode 173 is formed as a semicircle in the embodiment of FIG. 5, the present invention is not limited thereto, and the electrode pattern may be formed in various suitable shapes capable of forming a capacitance between the transmission electrode 171 and the reception electrode 173, such as a lozenge shape, a rectangular shape, a diamond shape, a direct line shape, or the like.

The transmission electrode 171 and the reception electrode 173 may be formed as one conductive layer of a device forming a pixel PX in the active area AA. For example, the transmission electrode 171 and the reception electrode 173 may be formed of the same material in the same layer as the gate electrode 133 or the source/drain electrode 134/135 forming the thin film transistor TFT or formed of the same material in the same layer as the first electrode 141 of the organic light-emitting device OLED.

A user's touch may be detected by a change in a capacitance between the transmission electrode 171 and the reception electrode 173. When a touch is detected, a function allocated to the touch sensor TS is performed. The function allocated to the touch sensor TS may be differently set according to a combination of the number of touches, a touch duration, and the like.

The touch sensors TS shown in FIGS. 4 and 5 are only illustrative, and the touch sensor TS of the present invention is not limited thereto and may be formed in various shapes.

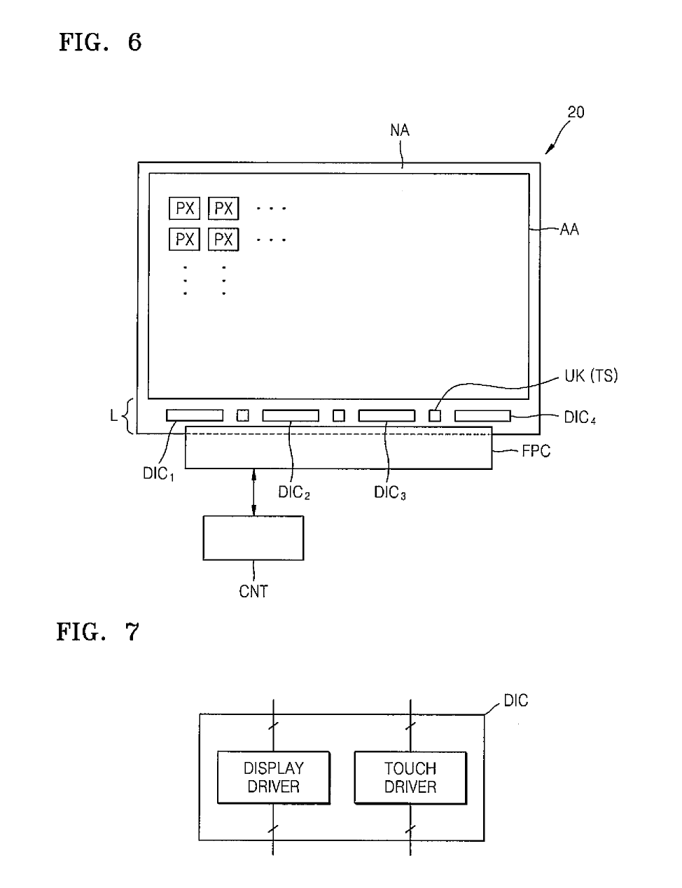

FIG. 6 is a top view of a display apparatus 20 according to another embodiment of the present invention. FIG. 7 is a block diagram of a DIC in the display apparatus 20 of FIG. 6.

Referring to FIGS. 6 and 7, the display apparatus 20 only differs from the display apparatus 10 of FIG. 1 in that a display driver and a touch driver are included in the DIC, and the other configuration of the display apparatus 20 is the same as the display apparatus 10 of FIG. 1. Thus, the same description as described with respect to the display apparatus 10 of FIG. 1 is omitted.

According to the embodiment illustrated in FIGS. 6 and 7, the display driver and the touch driver are integrated in the DIC, and thus, the DIC may directly transmit a touch detection signal to the control unit CNT. Accordingly, because a separate DIC for integrating the touch driver is not necessary, a manufacturing process thereof is easy, and the number of wirings can be reduced, thereby further restraining an increase in a product unit price.

According to the present invention, by mounting a user interface key near a driver for a display panel, costs may be reduced, and the usage of a product design may be enhanced, and by reducing the thickness of a bezel, a compact display apparatus may be provided.

In addition, a compact display apparatus may be provided by forming a touch sensor in a display panel.

While the present invention has been particularly shown and described with reference to example embodiments thereof, it will be understood by those of ordinary skill in the art that various changes in form and details may be made therein without departing from the spirit and scope of the present invention as defined by the following claims, and their equivalents.

What is claimed is:

1. A thin film transistor array substrate comprising:
an active area comprising a plurality of pixels;
a driver integrated circuit in a non-active area around the active area and configured to supply a driving signal to the pixels; and
a user input key positioned near the driver integrated circuit and configured to receive a user input.

2. The thin film transistor array substrate of claim 1, wherein the user input key comprises a touch sensor.

3. The thin film transistor array substrate of claim 1, wherein the driver integrated circuit comprises a display driver configured to supply a driving signal to the active area.

4. The thin film transistor array substrate of claim 2, wherein the driver integrated circuit is plural in number, wherein the plurality of driver integrated circuits are separated from each other, and
the touch sensor is between the plurality of driver integrated circuits.

5. The thin film transistor array substrate of claim 2, further comprising a touch driver configured to drive the touch sensor.

6. The thin film transistor array substrate of claim 5, wherein the touch driver is integrated in the driver integrated circuit.

7. The thin film transistor array substrate of claim 2, wherein the touch sensor is configured to detect a touch based on a change in capacitance between a pair of electrodes.

8. The thin film transistor array substrate of claim 7, wherein the pair of electrodes are at a same layer and are separated from each other.

9. The thin film transistor array substrate of claim 8, wherein the pair of electrodes are formed of a same material as one conductive layer of a device forming a pixel included in the active area.

10. A display apparatus comprising:
a substrate comprising an active area and a non-active area around the active area;
a plurality of pixels in the active area;
a plurality of driver integrated circuits in the non-active area and configured to supply a driving signal to the pixels; and
a user input key between at least two of the driver integrated circuits and configured to receive a user input.

11. The display apparatus of claim 10, wherein the user input key comprises a touch sensor.

12. The display apparatus of claim 10, wherein each of the plurality of driver integrated circuits comprises a display driver configured to supply a driving signal to the active area.

13. The display apparatus of claim 11, further comprising a touch driver for driving the touch sensor.

14. The display apparatus of claim 13, wherein the touch driver is integrated in at least one of the driver integrated circuits.

15. The display apparatus of claim 10, further comprising:
an encapsulation member facing the substrate; and
a touch panel on the encapsulation member.

16. The display apparatus of claim 11, wherein the touch sensor detects a touch based on a change in capacitance between a pair of electrodes.

17. The display apparatus of claim 16, wherein the pair of electrodes are at a same layer and separated from each other.

18. The display apparatus of claim 8, wherein the pair of electrodes are formed of a same material as one conductive layer of a device forming a pixel.
